(19) United States
(12) Patent Application Publication
(10) Pub. No.: US 2005/0149771 A1
(43) Pub. Date: Jul. 7, 2005

(54) Processor control circuit, information processing apparatus, and central processing unit

(75) Inventors: Akinari Todoroki, Hachioji-shi (JP); Shoji Hoshina, Kawasaki-shi (JP); Masakazu Isomura, Setagaya-ku (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/968,876

(22) Filed: Oct. 21, 2004

(30) Foreign Application Priority Data
Nov. 7, 2003 (JP) 2003-378367
Feb. 13, 2004 (JP) 2004-036747
Sep. 29, 2004 (JP) 2004-283611

(51) Int. Cl. G06F 1/30

(52) U.S. Cl. 713/300

(57) ABSTRACT

Power consumption by a processor can be reduced without impairing the efficiency of processing by the processor.

When a processor 2 inquires the operating status of a DMA controller 4 during a DMA operation, a clock controller 5 stops the supply of a clock signal to the processor 2 to prohibit the processor 2 from making inquiries about the operating status of the DMA controller 4. According to this arrangement, the processor 2 can continue processing until the processor 2 inquires the operating status of the DMA controller 4, that is, until it outputs a state-indication-register-read request signal, even if the DMA operation is being performed in the DMA controller 4. When the processor 2 outputs a state-indication-register-read request signal, the clock signal supply to the processor 2 is stopped.

### BACKGROUND OF THE INVENTION

1. Field of the Invention

The present invention relates to a processor control circuit controlling the operating status of a processor during a predetermined process executed without processor intervention, an information processing apparatus executing a predetermined process without processor intervention, and a central processing unit controlling the operating status of the processor during execution of a predetermined process executed without processor intervention.

2. Description of the Related Art

Technologies have been known that reduce power consumption by stopping the supply of clock signals to processor during a DMA (Direct Memory Access) processing mode operation by a DMA controller, namely during DMA operations by an I/O unit and a memory (see Japanese Patent Laid-Open No. 8-83133, for example).

However, these prior-art technologies can impair the efficiency of processing by processor because the processor is unable to perform processing due to the lack of clock signals during every DMA operation.

An object of the present invention is to solve the outstanding problem with the prior art and provide a processor control circuit and an information processing apparatus that can reduce power consumption by a processor without impairing the efficiency of processing by the processor.

### SUMMARY OF THE INVENTION

To solve the above-mentioned problem, a processor control circuit of a first aspect of the present invention includes a function unit capable of executing a predetermined process without the intervention of a processor, and a suppressing unit, which, when said processor makes an inquiry about the operating status of the function unit during the execution of the predetermined process, suppresses operations relating to inquiries about the operating status of the function unit from the processor until the predetermined process is completed.

To suppress operations relating to inquiries about the operating status of the function unit, the frequency of such inquiries may be lowered or such inquires may be prohibited.

A processor control circuit of a second aspect of the present invention is characterized in that when the processor makes an inquiry about the operating status of the function unit during execution of the predetermined process, the suppressing unit delays the operation relating to the inquiry about the operating status of the function unit from the processor until the predetermined process ends.

A processor control circuit of a third aspect of the present invention is characterized in that when the processor makes an inquiry about the operating status of the function unit during the execution of the predetermined process, the suppressing unit lowers the frequency of a clock signal being supplied to the processor and maintains the lowered frequency until the predetermined process ends.

According to the first to third aspects of the present invention, the processor can continue processing until the processor inquires the operating status of the function unit, even if the predetermined process is performed in the function unit. When the processor inquires the operating status of the function unit, inquires about the operating status of the function unit from the processor is suppressed. Therefore, power consumption by the processor can be reduced without impairing the efficiency of processing by the processor.

A processor control circuit of a fourth aspect of the present invention is characterized in that, when the processor makes an inquiry about the operating status of the function unit during execution of the predetermined process, the suppressing unit stops the supply of a clock signal to the processor until the predetermined process ends.

According to the fourth aspect of the present invention, switching operation of transistors contained within the processor is stopped and consequently power consumption by the processor can be reduced.

A processor control circuit of a fifth aspect of the present invention is characterized in that the suppressing unit is capable of temporarily resuming supplying the clock signal while the supply of the clock signal is stopped.

A processor control circuit of a sixth aspect of the present invention is characterized in that the function unit is capable of executing a Direct Memory Access (DMA) processing and the suppressing unit temporarily resumes the supply of the clock signal every time data of a predetermined length is DMA-transferred while the supply of the clock signal is stopped.

According to the fifth and sixth aspects of the present invention, even if clock signal supply to the processor is stopped during a DMA operation, the clock signal supply can be resumed temporarily before the completion of the DMA operation, that is, during the DMA operation.

A processor control circuit of a seventh aspect of the present invention is characterized in that the function unit comprises a state storage unit for storing execution status information indicating the operating status of the function unit and, when the processor makes an inquiry about the operating status by reading the execution status information, the function unit outputs a read completion signal indicating the completion of the read of the execution status information to the processor to inform that the predetermined process in the function unit has ended.

According to the seventh aspect of the present invention, the processor can inquire the operating status by reading the execution status information and accordingly a process for detecting the execution status of a predetermined process can readily be programmed.

To solve the above-mentioned problem, an information processing apparatus of a eighth aspect of the present invention includes a processor executing predetermined processing; a function unit capable of executing a predetermined process without the intervention of the processor; and a suppressing unit which, when the processor makes an inquiry about the operating status of the function unit during execution of the predetermined process, suppresses operations relating to the inquiry about the operating status of the function unit from the processor until the predetermined process ends.

As with the first aspect of the present invention, to suppress operations relating to inquiries about the operating status of the function unit, the frequency of such inquiries may be lowered or such inquires may be prohibited.

An information processing apparatus of a ninth aspect of the present invention is characterized in that, when the processor makes an inquiry about the operating status of the function unit during execution of the predetermined process, the suppressing unit delays the operation relating to the inquiry about the operating status of the function unit from the processor until the predetermined process ends.

An information processing apparatus of a tenth aspect of the present invention is characterized in that, when the processor makes an inquiry about the operating status of the function unit during the execution of the predetermined process, the suppressing unit lowers the frequency of a clock signal being supplied to the processor and maintains the lowered frequency until the predetermined process ends.

According to the eighth to tenth aspects of the present invention, the processor can continue processing until the processor inquire the operating status of the function unit even if a predetermined process is performed in the function unit. When the processor inquires the operating status of the function unit, inquires about the operating status of the function unit from the processor is suppressed. Therefore, power consumption by the processor can be reduced without impairing the efficiency of processing by the processor.

An information processing apparatus of a eleventh aspect of the present invention is characterized in that, when the processor makes an inquiry about the operating status of the function unit during the execution of the predetermined process, the suppressing unit stops the supply of a clock signal to the processor until the predetermined process ends.

According to the eleventh aspect of the present invention, switching operation of transistors contained within the processor is stopped and consequently power consumption by the processor can be reduced.

An information processing apparatus of a twelfth aspect of the present invention is characterized in that the suppressing unit is capable of temporarily resuming supplying the clock signal while the supply of the clock signal is stopped.

An information processing apparatus of a thirteenth aspect of the present invention is characterized in that the function unit is capable of executing a Direct Memory Access (DMA) operation and the suppressing unit temporarily resumes the supply of the clock signal every time data of a predetermined length is DMA-transferred while the supply of the clock signal is stopped.

According to the twelfth and thirteenth aspects of the present invention, even if clock signal supply to the processor is stopped during a DMA operation, the clock signal supply can be resumed temporarily before the completion of the DMA operation, that is, during the DMA operation.

An information processing apparatus of a fourteenth aspect of the present invention is characterized in that: the function unit comprises a detection condition storage unit for storing detection condition information indicating a detection condition relating to the operating status of the function unit; the processor writes the detection condition information setting a predetermined condition for detecting the operating status into the detection condition storage unit to make an inquiry about the operating status; and, when the operating status meets the condition indicated by the detection condition information, the function unit outputs a write completion signal indicating the completion of the write of the detection condition information to the processor to inform that the predetermined process in the function unit has ended.

An information processing apparatus of a fifteenth aspect of the present invention is characterized in that: the function unit is capable of executing a plurality of the predetermined processes; the processor writes into the detection condition storage unit the detection condition information including information identifying the plurality of processes and the detection condition for detecting an operating status set among the plurality of predetermined processes; and when an operating status among the predetermines processes that is indicated by the detection condition information meets the detection condition, the function unit outputs the write completion signal to the processor.

According to the fourteenth and fifteenth aspects of the present invention, when the processor inquires the operating status of the function unit, detection condition information indicating a condition for detecting the operating status will be written. Therefore, if a plurality of predetermined processes are executed in the function unit in a situation where, for example, a plurality of DMA channels are available, complex conditions in those channels can be set for inquiring the operating status. Therefore efficient control of execution of software programs can be achieved.

Thus, the present invention can provide a processor control circuit and an information processing apparatus that can reduce power consumption by a processor without impairing the efficiency of processing by the processor.

A central processing unit of a sixteenth aspect of the present invention includes a function unit capable of executing a predetermined process without the intervention of a processor; an operation stopping unit for stopping the operation of the processor when the processor makes an inquiry about the execution status of the predetermined process during the predetermined process; an operation resuming unit for causing the processor to resume the operation when the predetermined process ends; an interrupt handling unit for causing the processor to execute interrupt handling when a request for initiating the interrupt handling occurs; and an inquiring unit for inquiring the operating status of the function unit from the processor when said interrupt handling ends.

A central processing unit of a seventeenth aspect of the present invention includes: a program counter for storing the address of an instruction code to be executed by the processor; and an exception program counter for storing an address obtained by decrementing the address stored in the program counter by one per-instruction-address value; wherein, when the interrupt handling ends, the inquiring unit stores the address stored in the exception program counter into the program counter.

According to the sixteenth and seventeenth aspects of the present invention, when a request for interrupt handling occurs while the operation of the processor is stopped, the operation of the processor is temporarily resumed and the interrupt handling is executed. After the completion of the interrupt handling, the operating status of the function unit is inquired and the operation of the processor is stopped again. Consequently, the instruction code succeeding the interrupted process can be prevented from being executed when the interrupt handling ends.

### BRIEF DESCRIPTION OF THE DRAWINGS

FIG. 1 is a schematic diagram showing a configuration of a processor control circuit according to a first embodiment of the present invention;

FIG. 2 is a flowchart of processing performed in a processor shown in FIG. 1;

FIGS. 3A to 3H are timing charts showing an operation of an information processing apparatus shown in FIG. 1;

FIG. 4 is a schematic diagram showing a configuration of a processor control circuit according to a second embodiment of the present invention;

FIG. 5 is a flowchart of a process performed in a processor shown in FIG. 4;

FIGS. 6A to 6H are timing charts showing an operation of an information processing apparatus shown in FIG. 4;

FIG. 7 is a block diagram schematically showing a configuration of an information processing apparatus 100 according to a third embodiment of the present invention;

FIG. 8 is a flowchart of a process performed in a processor shown in FIG. 7;

FIG. 9 is a diagram showing how a number of state machines indicating the operating status of DMA operate;

FIG. 10 is a diagram showing an exemplary data structure of detection condition information;

FIG. 11 is a block diagram schematically showing a configuration of a state-indication section 104a;

FIGS. 12A to 12H are timing charts showing an operation of the information processing apparatus shown in FIG. 7;

FIG. 13 is a diagram showing an exemplary configuration of the state-indication section when determining only an AND condition;

FIG. 14 is a diagram showing an exemplary configuration of the state-indication section 104a when determining only an OR condition;

FIG. 15 is a flowchart of a process performed in a prior-art processor;

FIG. 16 is a schematic diagram showing an embodiment of a central processing unit according to the present invention;

FIGS. 17A to 17D are timing charts showing an operation of a central processing unit shown in FIG. 1; and

FIGS. 18A to 18E are timing charts showing an operation of the central processing unit shown in FIG. 1.

### DETAILED DESCRIPTION OF THE PREFERRED EMBODIMENTS

Embodiments of the present invention will be described below with reference to the accompanying drawings.

### First Embodiment

An embodiment of a processor control circuit of the present invention will be described first.

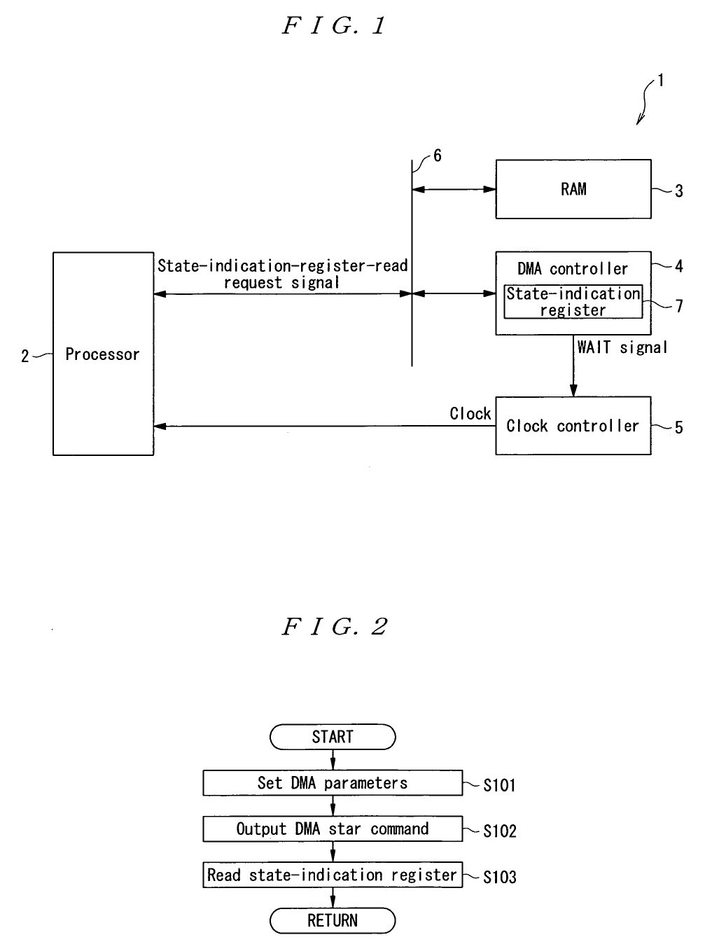

FIG. 1 is a block diagram schematically showing an configuration of an information processing apparatus 1 including a processor control circuit according to a first embodiment of the present invention. As shown in FIG. 1, the information processing apparatus 1 includes a processor 2, a RAM (Random Access Memory) 3, a DMA (Direct Memory Access) controller 4 having a state-indication register 7, and a clock controller 5. The components, except the clock controller 5, are interconnected through a data bus 6 in such a manner that they can exchange data one another.

Among these components, the processor 2 reads programs such as basic control and application programs and data stored in a storage device, which is not shown, loads them into a work area provided in the RAM 3, and executes them. Then, it performs various processes such as control of the components of the information processing apparatus 1 and arithmetic processing.

As shown in FIG. 2, the processor 2 also sets parameters for a DMA operation (DMA parameters) (step S101) and outputs a DMA start command for causing the DMA controller 4 to start the DMA operation (step S102). The processor 2 then outputs state-indication-register-read-request signal to the DMA controller 4 to obtain operation state of the DMA. Once a DMA execution state flag indicting that the DMA operation is not being executed is read out from the DMA controller 4, the processor 2 stops outputting the state-indication-register-read-request signal, and the read of the state-indication-register ends (step S103). It should be noted that the processor 2 continues outputting a state-indication-register-read-request signal even if the supply of clock signals is stopped while it is outputting the state-indication-register-read-request signal.

The RAM 3 provides a work area in which programs are loaded when the above-described process is performed by the processor 2 according to the programs and also provides a memory area for holding data relating to processes performed by the processor 2.

When a DMA start command is issued from the processor 2, the DMA controller 4 starts a DMA operation.

When a state-indication-register read-request signal is inputted from the processor 2, the DMA controller 4 determines whether a DMA operation is being performed. If not, the DMA controller 4 causes the processor 2 to read a DMA execution flag stored in the state-indication register 7 that indicates that no DMA operation is being executed. If a DMA operation is being performed, the DMA controller 4 output a WAIT signal to the clock controller 5 to prevent clock signals being supplied to the processor 2.

The clock controller 5 determines whether or not a WAIT signal is outputted from the DMA controller 4. If not, the clock controller supplies a clock signal to the processor 2. If a WAIT signal is outputted, the clock controller 5 stops supplying a clock signal.

An operation of the information processing apparatus 1 will be detailed below.

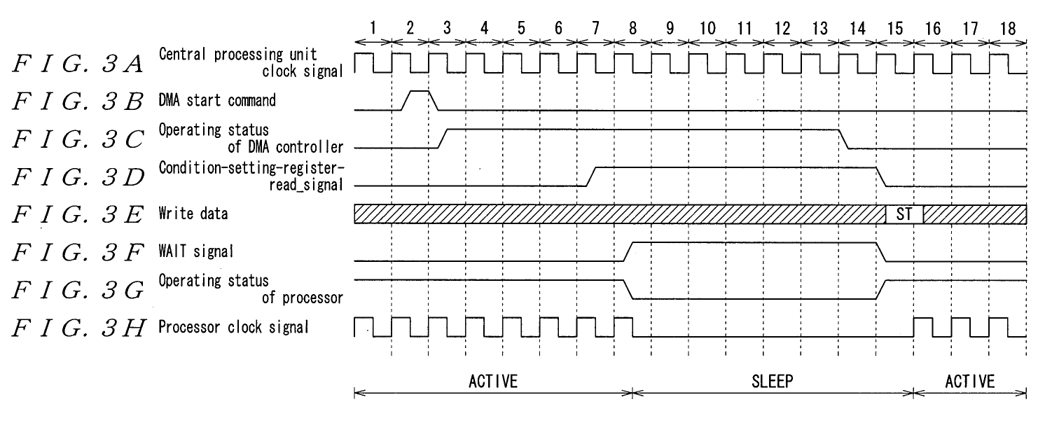

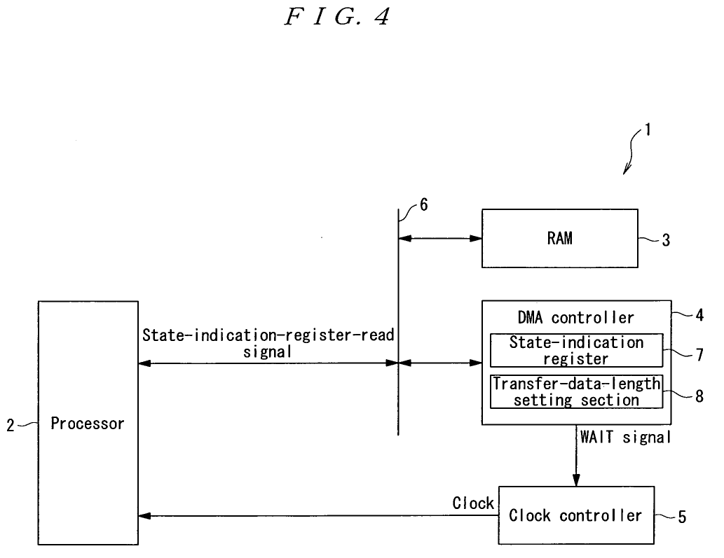

It is assumed here that a DMA request signal has been outputted to the DMA controller 4 in cycle 2 for requesting the DMA controller 4 to start a DMA, as shown in FIGS. 3A to 3H. Then, in cycle 3, the DMA controller 4 outputs a signal informing that a DMA is being transferred. The processor 2 performs a predetermined process. As shown in FIG. 2, DMA parameters are set at step S101 and a DMA start command is provided to the DMA controller 4 at step S102, as shown in FIG. 3B. Then, in cycle 3, the operating status of the DMA controller 4 becomes the “in-operation” state and the DMA controller 4 stars the DMA operation.

The DMA operation is continued in cycles 4 through 6, then a state-indication-register-read request-signal is provided from the processor 2 to the DMA controller 4 in cycle 7 as shown in FIG. 3D. Then, in cycle 8, a high WAIT signal is provided from the DMA controller 4 to the clock controller 5 as shown in FIG. 3F. In cycle 9, the clock controller 5 stops the supply of the operation clock signal to the processor 2, as shown in FIG. 3H.

After cycles 10 to 13, the operating status of the DMA controller 4 is force low as shown in FIG. 3C and the DMA operation ends.

Then, in cycle 15, a DMA execution state flag indicating that no DMA operation is being performed is read by the DMA controller 4 into the processor 2, the WAIT signal is made inactive, and the supply of the clock signal from the clock controller 5 to the processor 2 is restarted. When the DMA execution state flag is read out, the output of state-indication-register-read-request signal is stopped and the processing by the processor 2 is restarted in cycle 16.

In this way, in the information processing apparatus 1 of the present embodiment, when a DMA operation is performed by the DMA controller 4, the processor 2 can continue a process until the processor 2 inquires the operating status of the DMA controller 4, that is, until it outputs a state-indication-register-read-request signal and, when a state-indication-register-read-request signal is outputted from the processor 2, the clock signal supply to the processor 2 is stopped. Thus, power consumption by the processor 2 can be reduced without impairing the efficiency of processing by the processor 2.

Furthermore, because clock signal supply is inhibited until the DMA operation ends, repeated inquiries about the operating status of the DMA controller 4 during the DMA can be prevented and consequently the power consumption by the processor 2 can be reduced.

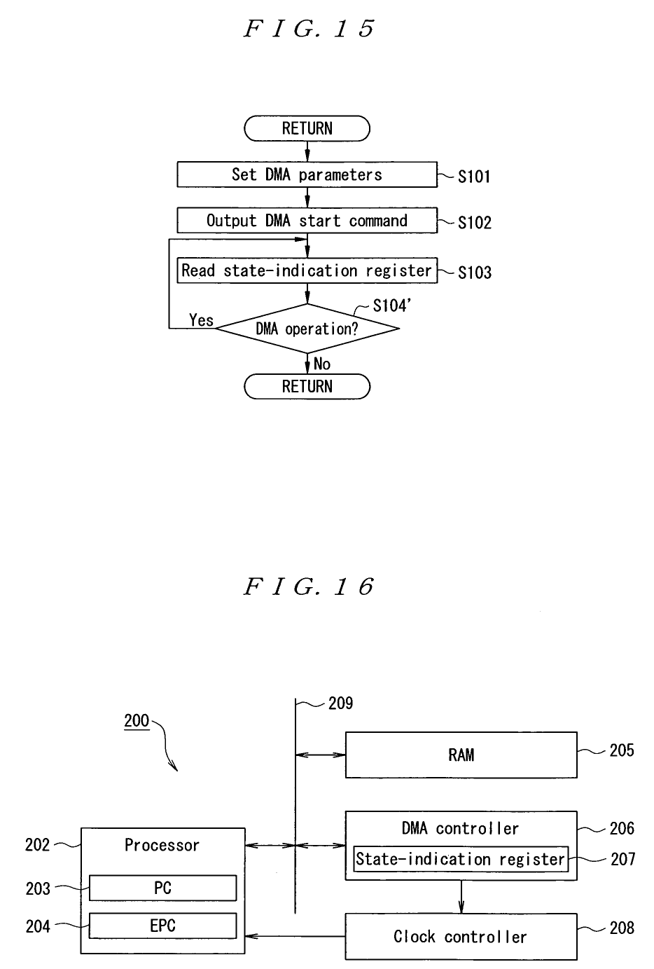

In contrast, in the prior-art method that causes a processor 2 to stop its operation during a DMA operation as shown in FIG. 15, the processor 2 itself must repeatedly inquire the operating status of the DMA controller 4 during the DMA operation and accordingly consumes more power.

In the information processing apparatus 1 of the present embodiment, the processor 2 can inquire the operating status of the DMA controller 4 by reading the status-indication register 7, which simplifies programming of the process for detecting a DMA operation.

### Second Embodiment

A second embodiment of a processor control circuit of the present invention will be described below.

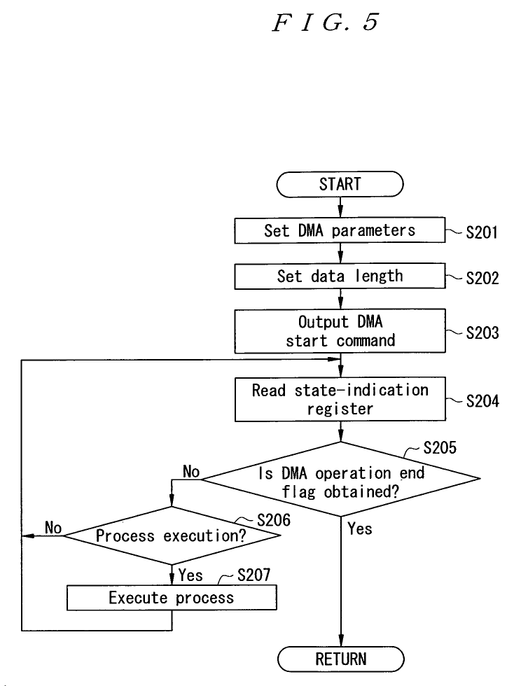

The second embodiment differs from the first embodiment in that the supply of the clock signal to a processor 2 is temporarily resumed each time data having a predetermined length is DMA-transferred during a period in which clock supply to the processor 2 is stopped. In particular, a transfer-data-length-setting section 8 is provided for setting the length of data to be DMA-transferred in a DMA controller 4 as shown in FIG. 4 so that a DMA execution state flag is read by the processor 2 each time data having that length is DMA-transferred to the DMA controller. Instead of the process shown in FIG. 2 performed by the processor 2 in the first embodiment, a control process in steps S201 to S207 shown in FIG. 5 is performed. The second embodiment includes equivalents of many of the components of the first embodiment. Like components are labeled with like reference numbers and detailed description of them will be omitted.

First, DMA parameters are set at step S201.

Then, the process proceeds to step S202, where the transfer-data-length-setting section 8 sets the length of data to be successively DMA-transferred, which means that the length of data for temporarily resuming the supply of a clock signal to the processor 2 is set.

The process then proceeds to step S204, where a state-indication-register-read-request signal is outputted to the DMA controller 4.

At step S205, the data length set by the transfer-data-length-setting section 8 is DMA-transferred, then the DMA transfer status is read from the state-indication-register 7 and, if the DMA transfer has been completed, the control flow in FIG. 5 will end. Otherwise, determination is made as to whether a predetermined process should be performed in processor 2 (step S206). If not, the control returns to step S204. Otherwise, the predetermined process is performed at step S207. After the completion of the predetermined process at step S207, the process returns to step S204.

An operation of an information processing apparatus 1 according to the second embodiment will be described in detail below.

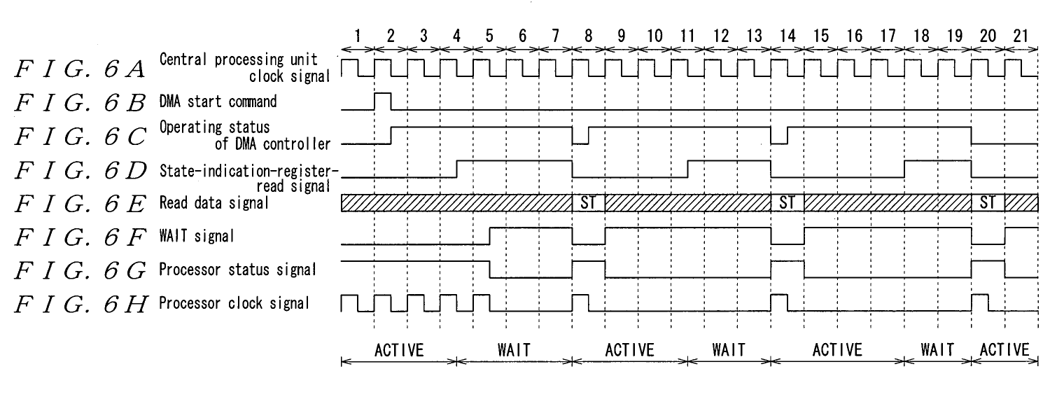

It is assumed here that a DMA request signal for requesting the DMA controller 4 to restart DMA is outputted in cycle 1 as shown in FIGS. 6A to 6H. Then, in cycle 2, the DMA controller 4 outputs a signal for informing that a DMA transfer operation is being performed. A predetermined process is performed by the processor 2 and DMA parameters are set at step S201 of the process as shown in FIG. 5. The length of data to be sequentially DMA transferred is set by the transfer-data-length-setting section 8 at step S202. At step S203, a high DMA start command is outputted to the DMA controller 4 as shown in FIG. 6B. Then the DMA operation is started by the DMA controller 4.

It is assumed here that, after cycle 3, a high state-indication-register-read-request command is outputted from the processor 2 to the DMA controller in cycle 4 during the DMA operation, as shown in FIG. 6D. Then, as shown in FIG. 6F, a high WAIT signal is provided from the DMA controller 4 to the clock controller in cycle 5. In cycle 6, an operating clock signal provided by the clock controller 5 to the processor 2 is stopped as shown in FIG. 6H.

After cycle 7, data having the length set by the transfer-data-length-setting section 8 is DMA-transferred and the operating status of the DMA controller is forced low. Then, a DMA execution status flag is read by the DMA controller 4 into the processor 2, the WAIT signal is stopped, and the supply of the clock signal is temporarily resumed by the clock controller 5. When the DMA execution status flag has been read, the state-indication-register-read-request signal is stopped. Because the DMA transfer has not yet been completed, determination at step S205 is “NO” and determination at step S206 is “YES.” Consequently, a predetermined process is performed at step S207. In cycle 9, a high state-indication-register-read-request signal is again provided from the processor 2 to the DMA controller 4.

Thus, according to the present invention, if clock signal supply to the processor is stopped during a DMA operation, it can be temporarily resumed before the completion of the DMA operation, namely during the DMA operation.

In this way, according to the second embodiment, the DMA controller 4 constitutes a function unit, the clock controller 5 constitutes a suppressing unit, and the state-indication-register 7 constitutes a status storage unit.

The second embodiment is an example of a processor control circuit according to the present invention and is not intended to limit its configuration and other features.

For example, while in the example of the second embodiment the clock signal supply is stopped when the state-indication-register-read-request signal is outputted from the processor 2, the embodiment is not so limited. For example, a clock signal of a low frequency may be provided to the processor 2 so that the frequency of readouts from the state-indication register 7 is lowered.

Furthermore, while clock signal supply to the processor 2 is stopped so as to completely stop the operation of the processor 2 (places the processor 2 in a WAIT state) in the above-described example, the embodiment is not so limited. For example, the processor 2 may activate an interrupt handler in response to an external interrupt (the processor 2 is places in a sleep state) while clock signal supply to the processor 2 is being stopped.

While clock signal supply to the processor 2 is controlled by the clock controller 5 in the above-described example, the embodiment is not so limited. For example, operations relating to inquiries about the operating status of the DMA controller made by the processor 2 may simply delayed until the completion of a DMA operation. This simplifies programs performed by the processor 2 and accordingly can improve the efficiency of processing by the processor 2 compared with a method in which the processor 2 performs polling during a DMA operation.

### Third Embodiment

An embodiment of an information processing apparatus of the present invention will be described below.

Unlike the processor 2 in the first embodiment that reads the state-indication-register 7 in order to inquire the operating status of the DMA controller 104, a processor 102 in the embodiment, which will be described below, writes particular information (detection condition information, which will be described below) into a condition-setting register 107 in order to inquire the operating status of a DMA controller 104.

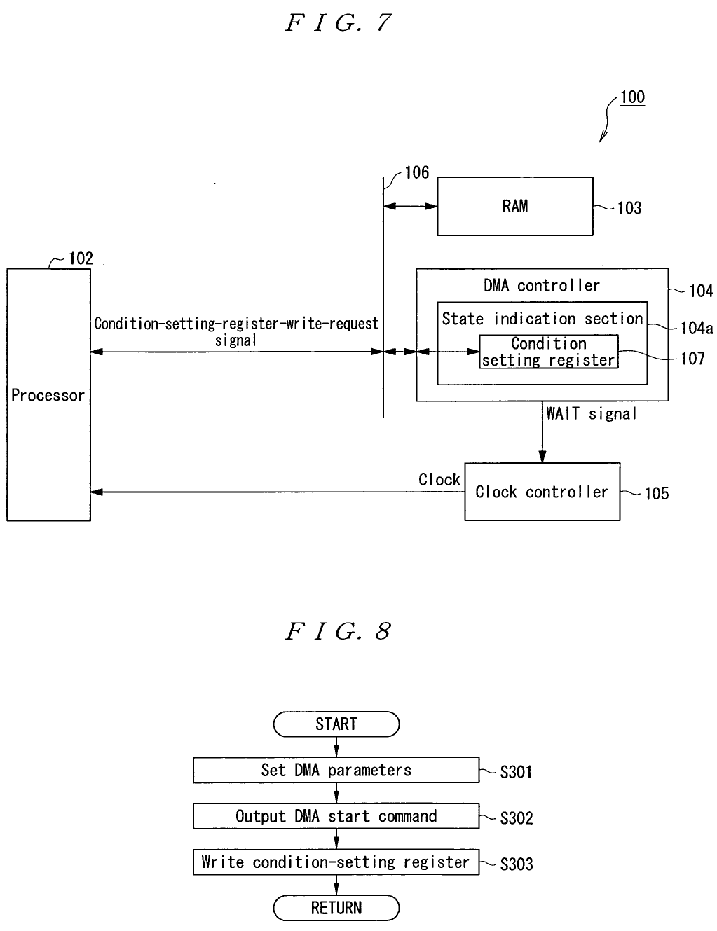

FIG. 7 is a block diagram schematically showing a configuration of the information processing apparatus 100 according to the third embodiment of the present invention. As shown in FIG. 7, the information processing apparatus 100 includes a processor 102, a RAM 103, a DMA controller 104 having a condition-setting register 107, and a clock controller 105. The components, excluding the clock controller 105 are interconnected through a data bus 106 in a manner that they can exchange data one another.

The processor 102 reads programs such as basic control programs and application programs and data stored in a storage device, which is not shown, loads and execute them in a work area provided in the RAM 103. Then, the processor 102 controls components of the information processing apparatus 100 and performs various processes.

Furthermore, as shown in the flowchart in FIG. 8, the processor 102 sets parameters for a DMA operation (DMA parameters) (step S301) and outputs a DMA start command to cause the DMA controller 104 to start the DMA operation (step S302). Then, the processor 102 outputs a condition-setting-register-write-request signal and its detection condition information (write data) to the DMA controller 104 in order to obtain the status of the DMA operation. When a write completion signal is outputted from the DMA controller 104 that indicates the completion of the write to the condition-setting register 107, the write to the condition-setting register 107 ends (step S303).

The detection condition information will be described below.

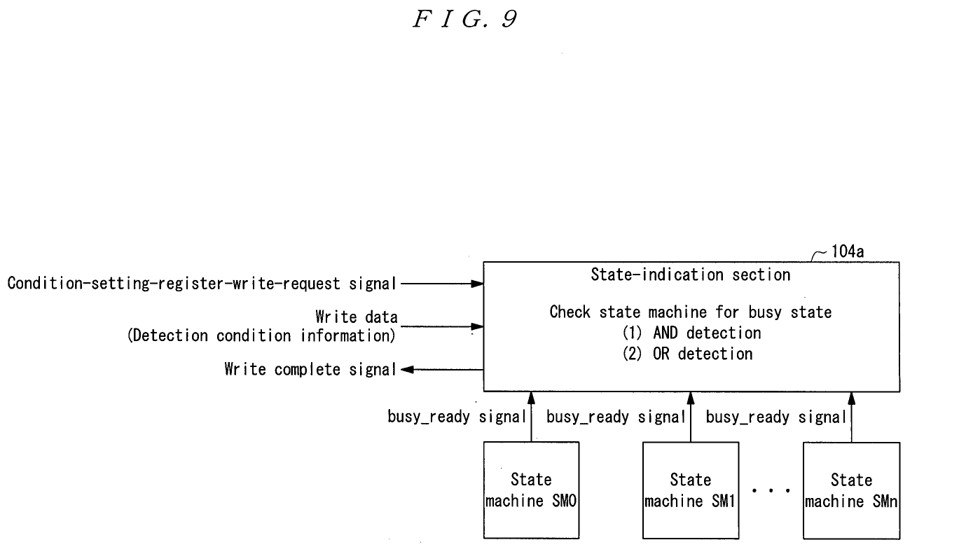

According to the present embodiment, a plurality of channels are provided in the DMA controller 104 so that DMA operations can be performed in a plurality of hardware modules concurrently. When more than one DMA transfers are made at a time, a plurality of state machines which indicate the status of DMA operations will be in operation as shown in FIG. 9. Detection condition information indicates a condition for detecting an operating status in the state machines SM0-SMn.

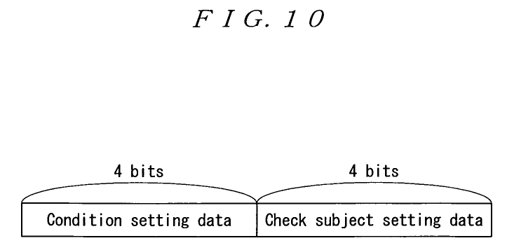

FIG. 10 shows an exemplary data structure of the detection condition information.

The detection condition information in FIG. 10 consists of 8-bit data. Each of the 4 low-order bits is bit data (hereinafter referred to as “check subject setting data”) indicating a specified state of each of four state machines SM0-SM3 (“1” indicates that the sate machine is need to be checked to see whether DMA transfer is being performed and “0” indicates that the state machine does not need to be checked) The 4 high-order bits are data (hereinafter referred to as “condition setting data”) indicating detection conditions set for the 4-low-order-bit data (“1000” indicates that an AND condition is set for the bit data and “1100” indicates that an OR condition is set for the bit data).

When the condition setting data (4 high-order bits) of the detection condition information is “1000,” a write completion signal is outputted from the DMA controller 104 unless all state machines (hardware modules) for which “1” is set in the check subject setting data (4 low-order bits) are performing DMA transfer. When the 4 high-order bits of the detection condition information are “1100,” a write completion data is outputted from the DMA controller 104 unless any of the state machines (hardware modules) is performing DMA transfer.

Returning to FIG. 7, when the processor 102 performs the above-described process according to programs, work area in which the programs are loaded as well as a memory area in which data relating to processes performed by the processor 102 is loaded are provided.

When a DMA start command is outputted from the processor 102, then DMA controller 104 starts a DMA operation.

The DMA controller 104 includes a state-indication section 104a for managing the status of a DMA operation. When a condition-setting-register-write request signal and detection condition information are inputted from the processor 102 to the DMA controller 104, the state-indication section 104a determines based on the detection condition information the status of the DMA operation, namely, the operating status of the state machines of the plurality of DMA channels. If the operating status of any of the state machines meets the detection condition indicated in the detection condition information, then the state-indication section 104a outputs a write completion signal that indicate the completion of a write to the condition setting register 107 to the processor 102. On the other hand, if the operating status of the state machine does not meet the detection condition indicated in the detection condition information, the state-indication section 104a outputs a WAIT signal to the clock controller 105.

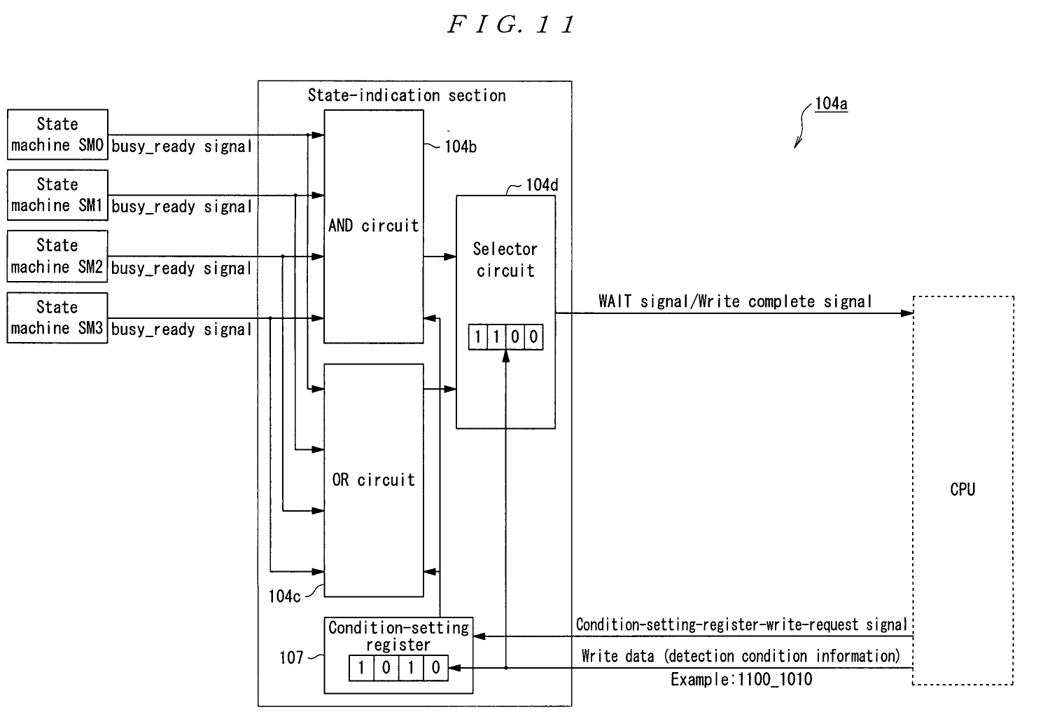

FIG. 11 is a block diagram schematically showing a configuration of the state-indication section 104a.

The state-indication section 104a in FIG. 11 includes the condition-setting register 107 describe above, an AND circuit 104b, an OR circuit 104c, and selector circuit 104d.

An input to the AND circuit 104b is a signal (busy_ready signal) from the state machine of each of hardware modules that are performing DMA transfer, indicating whether it is performing DMA transfer. The busy_ready signal is set to “1” if the hardware module is performing DMA transfer. Otherwise, the signal is set to “0.” Another input into the AND circuit 104b is bit data (check subject setting data) stored in the condition-setting register 107.

The AND circuit 104b checks the busy_ready signals inputted from hardware modules to see the operating status of hardware modules (state machines) for which “1” is set in the check subject setting data. If all busy_ready signals inputted from the hardware modules for which “1” is set in the check subject setting data are “0” (which means that none of them are performing DMA transfer), then the AND circuit 104b outputs an AND condition result indicting that the detection condition in the AND circuit 104b is met (“1,” in this example) to the selector circuit 104d. On the other hand, if not all busy_ready signals inputted from the hardware modules for which “1” is set in the check subject setting data is “0” (which means that any of them are performing DMA transfer), the AND circuit 104b outputs an AND result indicating that the detection condition in the AND circuit 104b is not met (“0,” in this example) to the selector circuit 104d.

As with the case of the AND circuit 104b, an input to the OR circuit 104c is a signal (busy_ready signal) from the state machine of each of hardware modules that are performing DMA transfer, indicating whether it is performing DMA transfer. Another input to the OR circuit 104c is bit data (check subject setting data) stored in the condition register 107.

The OR circuit 104c checks the busy_ready signals inputted from the hardware modules to see the operating status of the hardware modules (state machines) for which “1” is set in the check subject setting data. If any of the busy_ready signals inputted from the hardware modules for which “1” is set in the check subject setting data is “0” (which means that one or more of them are not performing DMA transfer), then the OR circuit 104c outputs an OR condition result indicating that the detection condition in the OR circuit 104c is met (“1,” in this example) to the selector circuit 104d. On the other hand, if all busy_ready signals inputted from the hardware modules for which “1” is set in the check subject setting data are “1” (which means that all of then are performing DMA transfer), then the OR circuit 104c outputs an OR condition result indicating that the detection condition in the OR circuit 104d is not met (“0,” in this example) to the selector circuit 104d.

Inputted to the selector circuit 104d is the condition setting data in the detection condition information provided from the processor 102.

Inputted into the selector circuit 104d are the condition result of AND from the AND circuit 104b and the condition result of OR from the OR circuit 104c.

The selector circuit 104d selects the AND condition result or the OR condition result, depending on the detection condition (AND condition or OR condition) indicated by the condition setting data and outputs the selected result to the processor 102. If the selected result is the AND condition or OR condition indicating that the condition is met, the selected result represents a write completion signal. If the selected result is the AND condition result or OR condition result indicating that the condition is not met, the selected result represents a WAIT signal for the processor 102.

Returning to FIG. 7, the clock controller 105 determines whether a WAIT signal is outputted from the DMA controller 104. If the Wait signal is not outputted, it supplies the clock signal to the processor 102. If the WAIT signal is outputted, the clock controller 105 stops clock signal supply.

An operation of the information processing apparatus 100 of the present embodiment will be described in detail below.

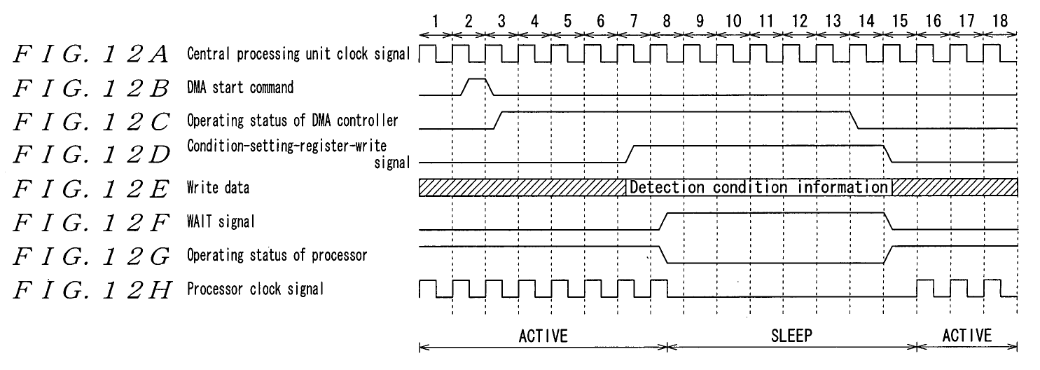

It is assumed here that a DMA request signal for requesting the DMA controller 104 to start a DMA operation is issued in cycle 2 as shown in FIGS. 12A to 12H.

Then, in cycle 3, a signal is outputted from the DMA controller 104 that indicates DMA transfer is being performed. A predetermined process is performed by the processor 102 and as shown in FIG. 8, DMA parameters are set at step 301. At step S302, a DMA start command is outputted to the DMA controller 104 as shown in FIG. 12B. In cycle 3, the operating status of the DMA controller becomes the “in-operation” state as shown in FIG. 12C and the DMA operation is started by the DMA controller 104.

During the DMA operation, after cycles 4 to 6, a condition-setting-register-write-request signal and write data (detection condition information) are outputted from the processor 102 to the DMA controller 104 in cycle 7 as shown in FIG. 12D.

Then, in cycle 8, a high WAIT signal is outputted from the DMA controller 104 to the clock controller 105 as shown in FIG. 12F. In cycle 9, an operating clock signal provided from the clock controller 105 to the processor 102 is stopped as shown in FIG. 12H.

After cycles 10 to 13, the operating status of the DMA controller 104 becomes low in cycle 14 as shown in FIG. 12C, indicating that the DMA operation has been completed.

Then, in cycle 15, a write completion signal indicating that no DMA operation is being performed is outputted from the DMA controller 104 to the processor 102 and the WAIT signal is stopped. When the clock signal supply to the processor 102 is resumed by the clock controller 105 and the write completion signal is outputted, the condition-setting-register-write-request signal is stopped and processing in the processor 102 is resumed in cycle 16.

Thus, according to the information processing apparatus 100 of the present embodiment, if a DMA operation is performed by the DMA controller 104, the processor 102 can continue processing until the processor 102 inquires the operating status of the DMA controller 104, that is, until the processor 102 outputs a condition-setting-register-write-request signal. Furthermore, when a condition-setting-register-write request signal is outputted from the processor 102, clock signal supply to the processor 102 is stopped, therefore power consumption by the processor 102 can be reduced without impairing the efficiency of processing by the processor 102.

Because clock signal supply is stopped until a DMA operation ends, repeated inquiries about the operating status of the DMA controller 104 during the DMA operation can be prevented and consequently power consumption by the processor 102 can be further reduced.

When the processor 102 outputs a condition-setting-register-write-request signal, detection condition information indicating a condition for detecting the operating status of the DMA controller 104 is outputted as write data. Therefore, if there are a plurality of channels of DMA, complex conditions in those channels can be set for inquiring the operating status of the DMA controller 104, therefore efficient control of execution of software programs can be achieved, in addition to the effects described above. In particular, because the frequency of determinations about conditions in a program can be reduced, the execution speed of the program can be improved. Compared with the prior-art approaches in which determinations about conditions are frequently performed due to pollings to a DMA controller, wasteful power consumption can be reduced. Moreover, because a process for detecting various conditions in the DMA controller 104 can be performed simply by outputting a write-request signal and detection condition information (wire data), programs for implementing such a process can readily be written.

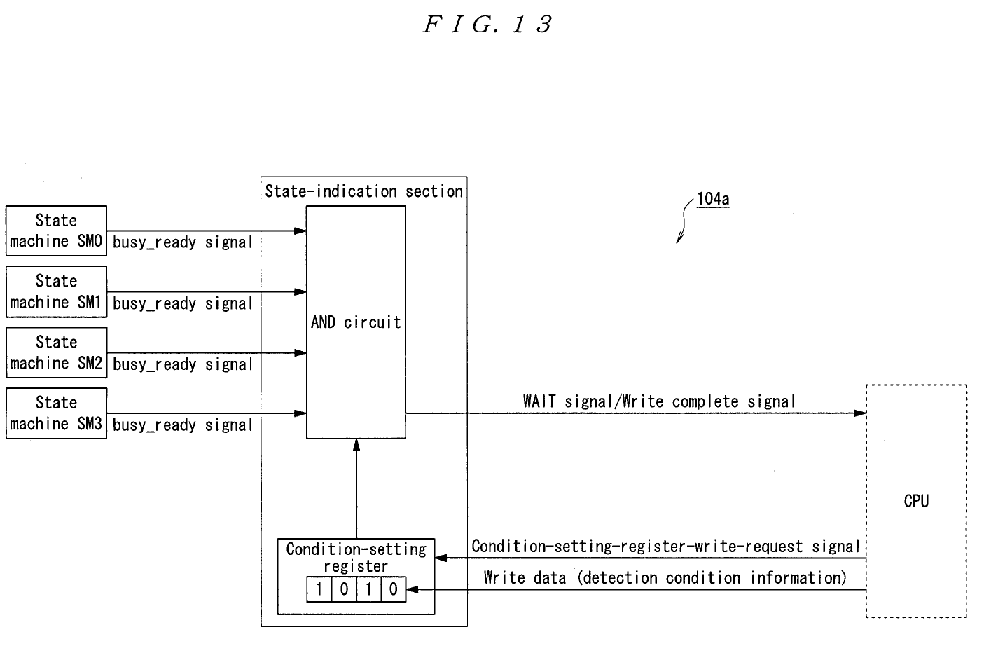

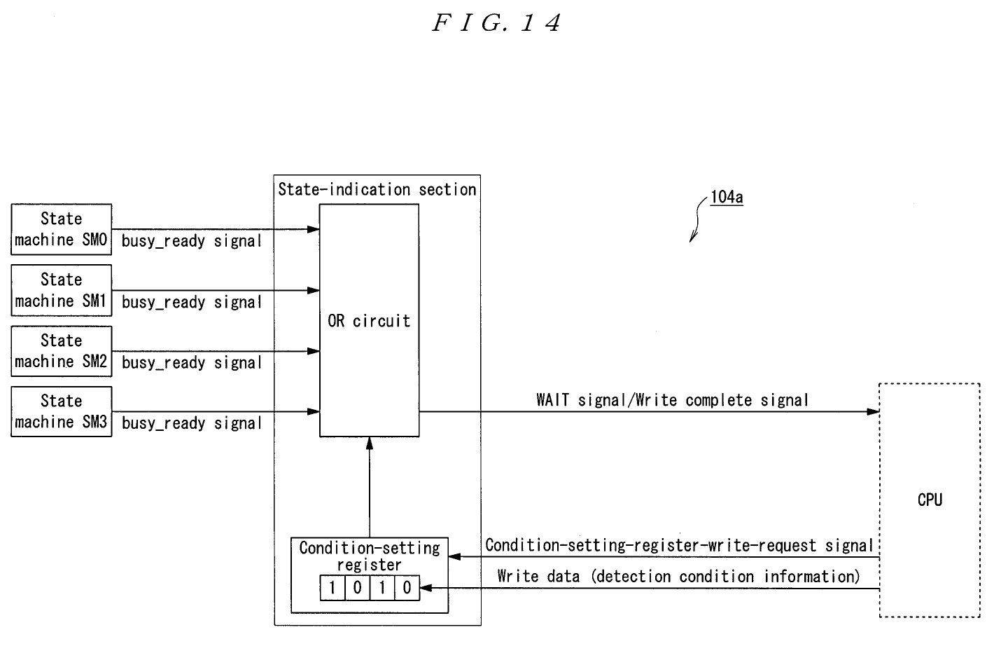

While in the present embodiment the DMA controller 104 makes determination as to whether an AND or OR condition indicated in the detection condition information is met, other conditions (such as an XOR condition) may be set, or the DMA controller 104 may determine whether one of AND and OR conditions is met. If the DMA controller 104 determines whether a single, fixed condition is met, the need for the 4 high-order bits of detection condition data can be eliminated and consequently the amount of data written by the processor 102 can be reduced and the configuration of the state-indication section 104a can be simplified as shown in FIGS. 13 and 14.

In the present invention, when a condition-setting register-write-request signal is outputted from the processor 102, clock signal supply to the processor 102 is stopped until a write completion signal is outputted from the DMA controller 104. However, supply of the clock signal may be temporarily resumed every time data of a predetermined length is DMA-transferred.

In the present embodiment, the processor 102 constitutes a processor in the claims, the DMA controller 104 constitutes a function unit, the clock controller 105 constitutes a suppressing unit, and the condition-setting register 107 constitutes a detection condition storage unit.

### Fourth Embodiment

A fourth embodiment addresses the following situation in the present invention.

Processors are commonly known that have a program counter for holding the address of an instruction code to be executed by the processors and an exception program counter for saving the address held in the program counter when an interrupt handling request is issued. In such a processor, when interrupt handling ends, the address saved in an exception program counter is stored in the program counter and program codes are sequentially executed, starting with the instruction code associated with the address stored in the program counter.

If this processor technology is applied to the first to third embodiments described above, clock signal supply to the processor would be stopped and the execution of an instruction by the processor would be interrupted when an access request to the RAM during a DMA operation and the processor inquires the execution status of the DMA operation. Furthermore, when interrupt handling is initiated while clock signal supply is stopped, the address held in the program counter is saved in the exception program counter the interrupt handling is executed. Therefore, when the interrupt handling is completed and the address saved in the exception program counter is stored in the program counter, the instruction code subsequent to a RAM access request may be executed even though the DMA operation is being executed.

On the other hand, if the initiation of interrupt handling is inhibited while clock signal supply is stopped in order to prevent the execution of the instruction code subsequent to an access request, the time that elapses between issuance of a request for interrupt handling and the start of the interrupt handling, namely the interrupt response time, would increase.

Described below is a central processing unit capable of preventing the instruction code succeeding an interrupted instruction from being executed when the interrupt handling ends.

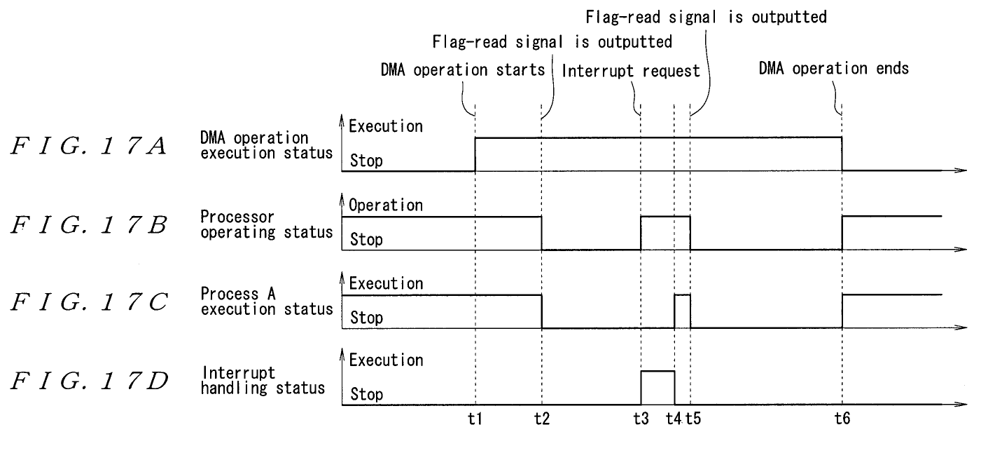

An embodiment of a central processing unit of the present invention will be described below with reference to FIGS. 16 and 17.

FIG. 16 is a block diagram schematically showing a configuration of a central processing unit according to an embodiment of the present invention. As shown in FIG. 16, the central processing unit 200 includes a processor 202 having program counter (PC) 203 and a exception program counter (EPC) 204, a RAM (Random Access Memory) 205, a DMA controller 206 having a state-indication-register 207, and a clock controller 208. The components, excluding the clock controller 208, are interconnected through a data bus 209 in a manner that they can exchange data with one another.

The processor 202 includes the program counter 203 for storing the address of an instruction code to be executed by the processor 202, and the execution program counter 204 for saving a value obtained by decrementing the address stored in the program counter 203 by one per-instruction-address value (for example “4” if the processor 202 is 32-bit based) when the clock signal supply to the processor 202 is stopped and a request for initiating the interrupt handling occurs. The processor 202 reads the instruction code associated with the address stored in the program counter 203 from the RAM 205 and performs processings according to the instruction code. Furthermore, after interruption handling ends, the processor. 202 stores the address saved in the exception program counter 204 into the program counter 203.

When a RAM 205 access request is issued, the processor 202 outputs to the DMA controller 206 a signal (hereinafter referred to as a “register read signal”) for reading a flag indicating the execution status of a DMA operation from the state-indication register 207 in the DMA controller 206. Then, if a flag indicating that no DMA operation is being performed (hereinafter also referred to as a “not-in-execution flag”) is read from the DMA controller 206, the processor 202 initiates access to the RAM 205.

Provided in the RAM 205 are a work area for loading an instruction code and data read from a storage device, which is not shown, and a memory area for storing data relating to processes performed by the processor 202 and data transferred by a DMA operation. Arbitration between a RAM 205 access request by the processor 202 and a RAM 205 access request by a DMA operation is performed by a memory interface, which is not shown.

The DMA controller 206 initiates a DMA operation when it receives a DMA initiation request signal. When a register read signal is provided from the processor 202, the DMA controller 206 determines whether or not a DMA operation is being executed on the RAM 205 at the address to which the processor intends to access. If a DMA operation is not being executed, the DMA controller causes the processor 202 to read the not-in-execution flag stored in the state-indication register 207. If a DMA operation is being performed, the DMA controller 206 outputs a WAIT signal to the processor 202 and the clock controller 208. If an interrupt handling request is provided during outputting the WAIT signal, the DMA controller 206 stops outputting the WAIT signal.

The clock controller 208 determines whether or not a WAIT signal is outputted from the DMA controller 206. If not, the clock controller 208 supplies a clock signal to the processor 202. If a WAIT signal is outputted, the clock controller stops clock signal supply.

An operation of the central processing unit 200 according to the present embodiment will be described in detail below.

It is assumed here that a DMA operation request signal is issued (time t1) during process A is executed by the processor 202, as shown in FIG. 17C. The processor 202 continues executing process A and the DMA controller 206 initiates the DMA operation. Then, data to be processed and instruction codes are read from the RAM 205 and relevant data is transferred to the RAM 205.

It is assumed here that an access request to the address in the RAM 205 on which the DMA operation is being performed is issued (time t2) during the execution of process A by the processor 202 and the processor 202 outputs a register read signal to the DMA controller 206. This means that the processor 202 cannot read data to process from the RAM 205 until the DMA operation ends. In this situation, the DMA controller 206 outputs a WAIT signal to the processor 202 and the clock controller 208 and the clock controller 208 stops clock signal supply to the processor 202. Then operations by the processor 202 is stopped but only the DMA operation is continued, as shown in FIGS. 17A and 17B.

If an interrupt handling request signal is issued (time t3) while the processor 202 is in the halt state, the DMA controller 206 stops outputting the WAIT signal, the clock controller 208 temporarily resumes the supply of the clock signal to the processor 202, and the processor 202 is placed in operation as shown in FIG. 17B. The processor 202 saves a value obtained by decrementing the address in the program counter by one per-instruction-address value. That is, it saves the address of the instruction that has caused the RAM 205 access request, in the exception program counter 204. Then, the interrupt handling is started as shown in FIG. 17D.

The execution of the interruption handling continues (from time t1 to t5) and when it ends, the processor 202 stores the address saved in the exception program counter 204 into the program counter 203. The processor 202 reads the instruction code associate with the address stored in the program counter 203 from the RAM 205 and executes again the instruction that has caused the RAM 205 access request according to the instruction code, as shown in FIG. 17C. Then, the processor 202 outputs a register read signal to the DMA controller 206, which then outputs a WAIT signal to the processor 202 and the clock controller 208. The clock controller 208 again stops supplying the clock signal to the processor 202 and the processor is placed in halt state, as shown in FIG. 17B.

In this way, in the central processing unit 200 of the present embodiment, when an interrupt handling request signal is issued while the operation of the processor 202 is halted, the operation of the processor 202 is resumed and interrupt handling is executed. When the interrupt handling ends, a register-read signal is outputted to the DMA controller 206 and the processor 202 is again placed in halt state. Therefore, a situation can be avoided where, after interrupt handling ends, the instruction code subsequent to a RAM 205 access request is executed even though the DMA operation is being performed.

If the DMA operation ends (time t6) while the processor 202 is in the halt state, the DMA controller 206 stops the output of the WAIT signal and the clock controller 208 completely restart supplying the clock signal to the processor 202 to place the processor 202 again in operation state. The processor 202 reads the instruction codes associated with the address stored in the program counter 203 from RAM 205, initiates access to the RAM 205 according to the instruction code, and resumes the process A as shown in FIG. 17C.

In the embodiment described above, the DMA controller 206 shown in FIG. 16 constitutes a function unit, and the DMA controller 206 and the clock controller 208 in FIG. 16 constitute a halting unit and a resume unit, respectively, the processor 202 and the DMA controller 206 and the clock controller 208 constitute an interrupt handling unit, and the processor 202 of FIG. 16 constitutes a inquiring unit.

The present embodiment is only illustrative of the central processing unit of the present invention and is not intended to limits its configuration and features.

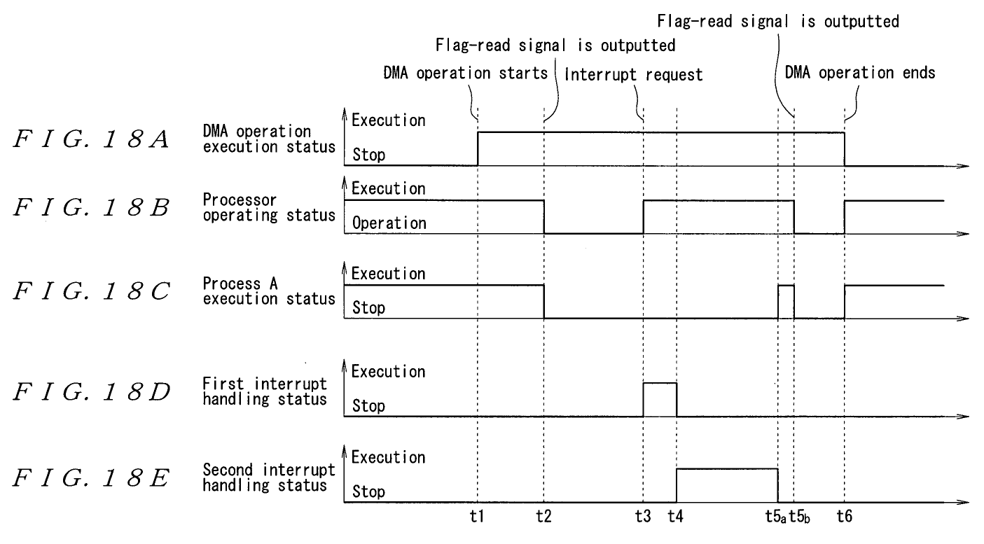

For example, while one interrupt occurs during the DMA operation in the example shown in FIGS. 17A to 17D, the embodiment is not so limited. Two interrupts (first and second interrupts) may be generated successively as shown in FIGS. 18A to 18E. Furthermore, an interrupt that causes a particular process to be executed may be generated during a DMA operation. This can prevent the instruction code succeeding the interrupted process from being executed when the particular process ends.

While the operation of the processor 202 is halted if the address in the RAM 205 that the processor 202 intends to access is being DMA-accessed in the example described above, the embodiment is not so limited. For example, the operation of the processor 202 may be halted simply when a RAM 205 access request occurs in the processor 202 during a DMA operation, regardless of the address in the RAM 205 that the processor 202 intends to access.

1. A processor control circuit comprising: a function unit capable of executing a predetermined process without the intervention of a processor; and a suppressing unit which, when said processor makes an inquiry about the operating status of said function unit during execution of said predetermined process, suppresses operations relating to an inquiry about the operating status of said function unit until said predetermined process ends.

2. The processor control circuit according to claim 1, wherein, when said processor makes an inquiry about the operating status of said function unit during execution of said predetermined process, said suppressing unit delays the operation relating to the inquiry about the operating status of said function unit from said processor until said predetermined process ends.

3. The processor control circuit according to claim 1, wherein, when said processor makes an inquiry about the operating status of said function unit during the execution of said predetermined process, said suppressing unit lowers the frequency of a clock signal being supplied to said processor and maintains the lowered frequency until said predetermined process ends.

4. The processor control circuit according to claim 1, wherein, when said processor makes an inquiry about the operating status of said function unit during execution of said predetermined process, said suppressing unit stops the supply of a clock signal to said processor until said predetermined process ends.

5. The processor control circuit according to claim 4, wherein said suppressing unit is capable of temporarily resuming supplying said clock signal while the supply of said clock signal is stopped.

6. The processor control circuit according to claim 5, wherein, said function unit is capable of executing a Direct Memory Access (DMA) processing and said suppressing unit temporarily resumes the supply of said clock signal every time data of a predetermined length is DMA-transferred while the supply of said clock signal is stopped.

7. The processor control circuit according to claim 1, wherein said function unit comprises a state storage unit for storing execution status information indicating the operating status of said function unit and, when said processor makes an inquiry about said operating status by reading said execution status information, said function unit outputs a read completion signal indicating the completion of the read of said execution status information to said processor to indicate that the predetermined process in said function unit has ended.

8. An information processing apparatus comprising: a processor executing predetermined processing; a function unit capable of executing a predetermined process without the intervention of said processor; and a suppressing unit which, when said processor makes an inquiry about the operating status of said function unit during execution of said predetermined process, suppresses operations relating to the inquiry about the operating status of said function unit from said processor until said predetermined process ends.

9. The information processing apparatus according to claim 8, wherein, when said processor makes an inquiry about the operating status of said function unit during execution of said predetermined process, said suppressing unit delays the operation relating to the inquiry about the operating status of said function unit from said processor until said predetermined process ends.

10. The information processing apparatus according to claim 8, wherein, when said processor makes an inquiry about the operating status of said function unit during the execution of said predetermined process, said suppressing unit lowers the frequency of a clock signal being supplied to said processor and maintains the lowered frequency until said predetermined process ends.

11. The information processing apparatus according to claim 8, wherein, when said processor makes an inquiry about the operating status of said function unit during the execution of said predetermined process, said suppressing unit stops the supply of a clock signal to said processor until said predetermined process ends.

12. The information processing apparatus according to claim 11, wherein said suppressing unit is capable of temporarily resuming supplying said clock signal while the supply of said clock signal is stopped.

13. The information processing apparatus according to claim 12, wherein: said function unit is capable of executing a Direct Memory Access (DMA) operation and said suppressing unit temporarily supplies said clock signal every time data of a predetermined length is DMA-transferred while the supply of said clock signal is stopped.

14. The information processing apparatus according to claim 8,
wherein said function unit comprises a detection condition storage unit for storing detection condition information indicating a detection condition relating to the operating status of said function unit;
said processor writes said detection condition information setting a predetermined condition for detecting the operating status into said detection condition storage unit to make an inquiry about said operating status; and,
when said operating status meets the condition indicated by said detection condition information, said function unit outputs a write completion signal indicating the completion of the write of said detection condition information to said processor to inform that the predetermined process in said function unit has ended.

15. The information processing apparatus according to claim 14, wherein:
said function unit is capable of executing a plurality of said predetermined processes;
said processor writes into said detection condition storage unit said detection condition information including information identifying said plurality of processes and the detection condition for detecting an operating status set among said plurality of predetermined processes; and
when an operating status among the predetermines processes that is indicated by said detection condition information meets the detection condition, said function unit outputs said write completion signal to said processor.

16. A central processing unit comprising a function unit capable of executing a predetermined process without the intervention of a processor; an operation stopping unit for stopping the operation of said processor when said processor makes an inquiry about the execution status of said predetermined process during said predetermined process; an operation resuming unit for causing said processor to resume the operation when said predetermined process ends; an interrupt handling unit for causing said processor to execute interrupt handling when a request for initiating said interrupt handling occurs; and an inquiring unit for inquiring the operating status of said function unit from said processor when said interrupt handling ends.

17. The central processing unit according to claim 16, comprising: a program counter for storing the address of an instruction code to be executed by said processor; and an exception program counter for storing an address obtained by decrementing the address stored in said program counter by one per-instruction-address value; wherein, when said interrupt handling ends, said inquiring unit stores the address stored in said exception program counter into said program counter.
